(19) United States
(12) Patent Application Publication
(10) Pub. No.: US 2018/0292523 A1
(43) Pub. Date: Oct. 11, 2018

(54) REMOTE MONITORING SYSTEM OF HUMAN ACTIVITY

(71) Applicant: SENS4CARE, Yokneam Illit (IL)

(72) Inventors: Meir ORENSTEIN, Haifa (IL); Oded HAMBURGER, Haifa (IL); Avital ORENSTEIN, Haifa (IL); Lilach HAMBURGER, Haifa (IL)

(21) Appl. No.: 15/577,972

(22) PCT Filed: May 31, 2016
(86) PCT No.: PCT/IL16/50561

§ 371 Date: Nov. 29, 2017

Related U.S. Application Data
(60) Provisional application No. 62/168,824, filed on May 31, 2015.

(51) Int. Cl. G01S 13/86; G01S 15/02; G01S 15/66; G01S 15/88; G01S 19/13; G01S 11/12; G01S 11/14

(52) U.S. Cl. CPC G01S 13/862; G01S 15/025; G01S 15/66; G08B 21/0492; G01S 19/13; G01S 11/12; G01S 11/14; G01S 15/88

(57) ABSTRACT

According to first aspect, system for remote monitoring object in predefined space comprising: sonar module and radar module mutually coupled for simultaneously acquiring data about object; processing subsystem configured to: control the sonar module and the radar module; process data; communicate information and instructions with external device. According to second aspect, system for proximity monitoring an object comprising: an array of non-contact sensors simultaneously acquiring data, wherein the data comprising vitals and position of the object; processing subsystem configured to: control array; process data; communicate information and instructions with external device. According to third aspect, a monitoring system comprising: one remote system; one proximity system; SONDAR server; and one control console. According to fourth aspect, method for remotely monitoring objects, with sonar module and radar module, comprising: selecting predefined space for monitoring by user utilizing a control console; determine set of events that categorize alerts; and monitoring the object.

### FIELD OF THE INVENTION

The present invention relates to remote monitoring. More particularly, the present invention relates to systems and methods for non-contact monitoring activity of humans and animals.

### BACKGROUND OF THE INVENTION

Recording of human activity using remote non-obstructive sensing has many applications, such as monitoring of endangered groups (including elders and children), and also monitoring of everyday activity at work, during training, or for security purposes. A typical camera can offer a rudimental monitoring solution, however privacy considerations limit such use and therefore prevent cameras performing the required activity monitoring in various scenarios.

For comprehensive monitoring, several parameters regarding the subject have to be collected. Specifically, the activity parameters (e.g. motion) and few major bio-medical indicators (e.g. respiratory rate/heart rate and also their variability) are collected. Sometimes audio indicators can also provide useful information. The information extracted from such parameters should encompass activity patterns (such as location, speed, acceleration), sometimes allowing determination of different body parts' motion, and simultaneously breath and heart activity, and audio signatures (for body sounds, distress etc.).

For many years the usage of microwave reflectometry (e.g. Doppler radar) to detect motion of a human body has been indicated in the art. Typically, radar is an object-detection system that uses electromagnetic waves to determine the range, altitude, direction, or speed of objects.

For example, the breathing rate can be extracted from monitoring of the motion of the chest wall (monitoring of heart rate under restricted condition is also possible). However, it can be predicted that most people may refuse participating in an environment with constant exposure to radio frequency waves even with completely harmless radiation.

Additionally, the usage of ultrasound based sonar in air has been shown to allow tracking of the physical location and velocity of people. Typically, sonar is a technique that uses sound wave propagation (usually underwater) to navigate, or detect objects on or under the surface of the water, such as other vessels.

Although many attempts were done to realize a commercial solution for comprehensive remote monitoring for human care using devices based on known practice, the success was poor especially in uncontrolled environments (similarly to regular home/office environment) and particularly when a cost effective solution is required.

It would therefore be advantageous to have a monitoring system capable of a reliable, continuously remote monitoring of activity patterns and medical indications in a “noisy” environment, such that the subject privacy is not compromised and without exposure to harmful radiation.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### SUMMARY OF THE INVENTION

According to a first aspect of the present invention, a system for remote monitoring at least one object in a predefined space, the system comprising: a sonar module and a radar module mutually coupled for simultaneously acquiring data about the at least one object; at least one processing subsystem configured to perform at least one of: control the sonar module and the radar module; process the data; communicate information and instructions with external device.

In some exemplary embodiments, the at least one object is selected from the group comprising: inanimate; humans; and animals.

In some exemplary embodiments, the predefined space is selected from the group comprising: an indoor space; and an indoor spaces comprising adjacent outdoor space.

In some exemplary embodiments, the simultaneously acquiring data about the at least one object is achieved by monitoring signals reflected back from the at least one object, wherein the signals reflected back from the at least one object results from ultrasonic waves and electromagnetic microwaves projected to the predefined space, and wherein the ultrasonic waves and the electromagnetic microwaves are projected from the sonar module and the radar module respectively.

In some exemplary embodiments, the system further comprises at least one of additional sensor, and wherein the additional sensors comprising: at least one distinction reader; at least one optical detector; and at least one audio sensor.

In some exemplary embodiments, the at least one RFID tag is attached to the at least one object, wherein an identification value embedded in each one of the at least one RFID tag is unique, and wherein the at least one RFID tag is utilized by the system to distinguish between at least two of the objects.

In some exemplary embodiments, the at least one distinction reader is configured to transmit interrogatory radio frequency (RF) signals and receive RF authentication replies from the at least one RFID tag, whereby the RF authentication replies identifies the at least one object.

In some exemplary embodiments, the at least one optical detector is configured to capture an image of the at least one object in the predefined space, and wherein the image is selected from the group comprising video image; stills image; and a combination thereof.

In some exemplary embodiments, the system further comprises the at least one audio sensor capable of detecting audio signals from the object, wherein the system is configured to analyze the audio signals in order to assist the at least one processing subsystem in determining the at least one object location.

In some exemplary embodiments, the at least one processing subsystem further comprises a controller, wherein the controller is configured to operate the sonar module; the radar module; and the at least one additional sensor; wherein the controller further configured to acquire data from the sonar module; the radar module; and the at least one additional sensor.

In some exemplary embodiments, the system further comprises at least one guiding module, wherein each guiding module of the at least one guiding module is mechanically coupled with at least one sensor selected from a group comprising of: the sonar module; the radar module; and the at least one optical detector; and wherein the at least one guiding module is operated by the controller.

In some exemplary embodiments, the at least one processing subsystem further comprises a processor, wherein the processor is configured to supervise the controller and process the data acquired by the controller to information.

In some exemplary embodiments, the at least one processing subsystem further comprises a communication unit, wherein the communication unit is configured to communicate the information to the external device and obtain instructions from the external device, and wherein the communication unit is further configured to communicate with the internet.

In some exemplary embodiments, the external device is a control console, wherein the control console is configured to display the information to a user, and wherein the control console is further configured to obtain instructions from the user.

In some exemplary embodiments, the system further comprises SONDAR server, wherein the SONDAR server is capable of integrating a plurality of systems for remote monitoring the at least one object in a predefined space, wherein the communicate information and instructions with external device further comprises communicating over the internet with the external device via a SONDAR server.

In some exemplary embodiments, the at least one processing subsystem is further configured to initialize an auto-calibration routine dedicated for calibrating the sonar module; the radar module; and the at least one additional sensor, and wherein the auto-calibration routine further comprises mapping objects in the predefined space.

In some exemplary embodiments, the system is utilized to detect a location of the at least one object in the predefined space, wherein the location is selected from a group comprising of motion patterns; movement tracking; abrupt position change.

In some exemplary embodiments, the system is utilized to detect a vitals of the at least one object in the predefined space, wherein the vitals are selected from a group comprising of bio-medical signals; sharp drop in breathing rate; heart rate; and respiratory rate.

In some exemplary embodiments, the information comprising elements, wherein the elements are selected from a group comprising of: alerts; vital information; bio-medical signals; sharp drop in breathing rate; heart rate; respiratory rate; motion patterns; movement tracking; abrupt position change and location; wherein the information further comprises a predefined set of attributes for each element; wherein an event indicate a conflict between an element and its set of attributes; and wherein a conflict trigger an alert.

In some exemplary embodiments, the system further comprises at least one pulsed sonar monitoring module (PSMM), wherein the PSMM employs short ultrasonic pulses method for accurate tracking a location of the at least one object in the predefined space.

According to another aspect of the present invention a system for proximity monitoring at least one object, the system comprising: an array of non-contact sensors simultaneously acquiring data, wherein the data comprising vitals and position of the at least one object; at least one processing subsystem configured to perform at least one of: control the array; process the data; communicate information and instructions with external device.

In some exemplary embodiments, the at least one object is selected from the group comprising: inanimate; humans; and animals.

In some exemplary embodiments, the simultaneously acquiring data about the at least one object is achieved by measuring physical phenomena associated with the at least one object.

In some exemplary embodiments, the array is embedded in a wearable item, and wherein the wearable item is adjacent to a predetermined area of the at least one object.

In some exemplary embodiments, the array comprising at least one of: at least one non contact electric field sensor capable of measuring electrical capacitance between the at least one non contact electric field sensor and the predetermined area of the at least one object, wherein the electrical capacitance is indicative of vital changes; at least one non contact magnetic field sensor capable of measuring electrical currents indicating changes of amounts of fluids near in the predetermined area of the at least one object; at least one non contact motion sensor capable of detecting the at least one object position and motion, wherein the motion sensor is a micromechanical transducer selected from a group comprising: an accelerometer, a magnetometer, a gyro, an altimeter, and a combination thereof; at least one non contact acoustic sensor configured to perform as stethoscope, wherein the at least one non contact acoustic sensor is ultrasensitive membrane microphone; and wherein each sensor of the array is integrated with a dedicated front end electronics (FEE); wherein, each FEE is configured to shape, sample, and hold an electrical signal representing a measurement of each sensor.

In some exemplary embodiments, the array further comprises a controller, wherein the controller is configured to: control the sensors of the array; acquire data from the sensors; transmit the data to the at least one processing subsystem; and receive instructions from the at least one processing subsystem.

In some exemplary embodiments, the at least one processing subsystem further comprises a processor, wherein the processor is configured to supervise the controller and process the data acquired by the controller to information.

In some exemplary embodiments, the at least one processing subsystem further comprises at least one communication unit (CU), wherein the at least one CU is configured to: transmit instructions to the controller; receive data from the controller; receive instructions from the external device; transmit the information to the external device; and communicate with the internet.

In some exemplary embodiments, the system further comprises at least one RFID tag, wherein the at least one RFID tag is attached to the at least one object, wherein an identification value embedded in each one of the at least one RFID tag is unique, wherein the at least one RFID tag is utilized by the system to distinguish between at least two of the objects, and wherein the at least one RFID tag is coupled with a panic button for manually indicating an alert.

In some exemplary embodiments, the at least one processing subsystem further comprises at least one RFID interrogator configured to transmit interrogatory radio frequency (RF) signals and receive RF authentication replies from the at least one RFID tag, and wherein the replies comprising the at least one object identification and alert indication are attached to the information.

In some exemplary embodiments, the system further comprises at least one global positioning satellite (GPS) module, wherein the GPS module is capable of determining location of the at least one object, and wherein the GPS module attach a depiction of the location to the information.

In some exemplary embodiments, the at least one processing subsystem is further configured to initialize an auto-calibration routine dedicated for calibrating the sensors of the array; and wherein the auto-calibration routine comprises utilizing the GPS for tracking the location of the at least one object.

In some exemplary embodiments, the at least one object carry the at least one processing subsystem.

In some exemplary embodiments, the position of the at least one object is selected from a group comprising of motion patterns; movement tracking; abrupt position change, and wherein the position depiction is attached to the information.

In some exemplary embodiments, the vital of the at least one object are selected from a group comprising of: bio-medical signals; sharp drop in breathing rate; heart rate; and respiratory rate; and wherein the vitals depiction is attached to the information.

In some exemplary embodiments, the at least one processing subsystem comprises attributes adequate for the at least one object; wherein an event indicate a conflict between the information and the attributes; and wherein a conflict automatically trigger an alert.

In some exemplary embodiments, the system further comprises an energy harvesting module configured to transform energy derived from external energy sources into electrical energy, wherein the external energy sources are selected from a group comprising of: solar energy; thermal energy; wind energy; kinetic energy; and a combination thereof; wherein the electrical energy is stored in a power storage, and wherein the system utilizes the power storage in a self-powered monitoring mode.

In some exemplary embodiments, the external device is a control console, wherein the control console is configured to display the information to a user, and wherein the control console is further configured to obtain instructions from the user.

In some exemplary embodiments, the system further comprises SONDAR server, wherein the SONDAR server is capable of integrating a plurality of systems for remote monitoring the at least one object in a predefined space, wherein said communicate information and instructions with external device further comprises communicating over the internet with the external device via a SONDAR server.

According to yet another aspect of the present invention a monitoring system comprising: at least one remote system, wherein each remote system of the at least one remote system monitor at least one object in a predefined space; at least one proximity system, wherein each proximity system of the at least one proximity system monitor at least one object; a SONDAR server; and at least one control console.

In some exemplary embodiments, the SONDAR server comprises a plurality of processing devices and a data repository, wherein the SONDAR is configured to: communicate information with the at least one remote system, the at least one proximity system, and the at least one control consoles; perform computations required by the at least one remote system and the at least one proximity system; retain information of at least one object in the data repository.

In some exemplary embodiments, the SONDAR server is capable of: synchronize between a remote system of the at least one remote system and a proximity system of the at least one proximity system in order to simultaneously monitor one of the at least one object, and change-over the monitoring from the remote system of the at least one remote system to the proximity system of the at least one proximity system and vice versa.

In some exemplary embodiments, the at least one control consoles, are configured to display the information to at least one user, and wherein the at least one control consoles are further configured to obtain instructions from the at least one user.

According to yet another aspect of the present invention a method for remotely monitoring at least one object, with a sonar module and a radar module, comprising: selecting a predefined space for monitoring by a user utilizing a control console; determine a set of events that categorize alerts; and monitoring the at least one object.

In some exemplary embodiments, the selecting a predefined space comprises: initializing an auto-calibration routine for calibrating the sonar module and the radar module; mapping objects in the predefined space; and choosing the at least one object for monitoring.

In some exemplary embodiments, the monitoring comprises acquiring data about the at least one object with the sonar module and the radar module simultaneously, and wherein the monitoring is conducted periodically until an event of the set of events is detected.

In some exemplary embodiments, the monitoring further comprising sending an alert to the user when an event of the set of events has been detected.

In some exemplary embodiments, method enables the user to modify the set of events that categorize alerts.

In some exemplary embodiments, the monitoring further comprises acquiring data about the at least one object with the sonar module, and wherein the monitoring is conducted periodically until an event of the modified set of events is detected.

In some exemplary embodiments, the monitoring further comprising triggering radar module monitoring for a predetermined period of time if an event of the modified set of events was detected, and wherein an alert is sent to the user if an event of the modified set of events has been detected by the radar in the predetermined period of time.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates a SONDAR monitoring system in accordance with some exemplary embodiments of the disclosed subject matter;

FIG. 2 schematically illustrates a proximity monitoring system in accordance with some exemplary embodiments of the disclosed subject matter; and

FIG. 3 shows a flowchart diagram of a method for remotely monitoring objects in accordance with some exemplary embodiments of the disclosed subject matter; and

FIG. 4 schematically illustrates an essential SONDAR monitoring system in accordance with some exemplary embodiments of the disclosed subject matter;

### DESCRIPTION OF THE PREFERRED EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

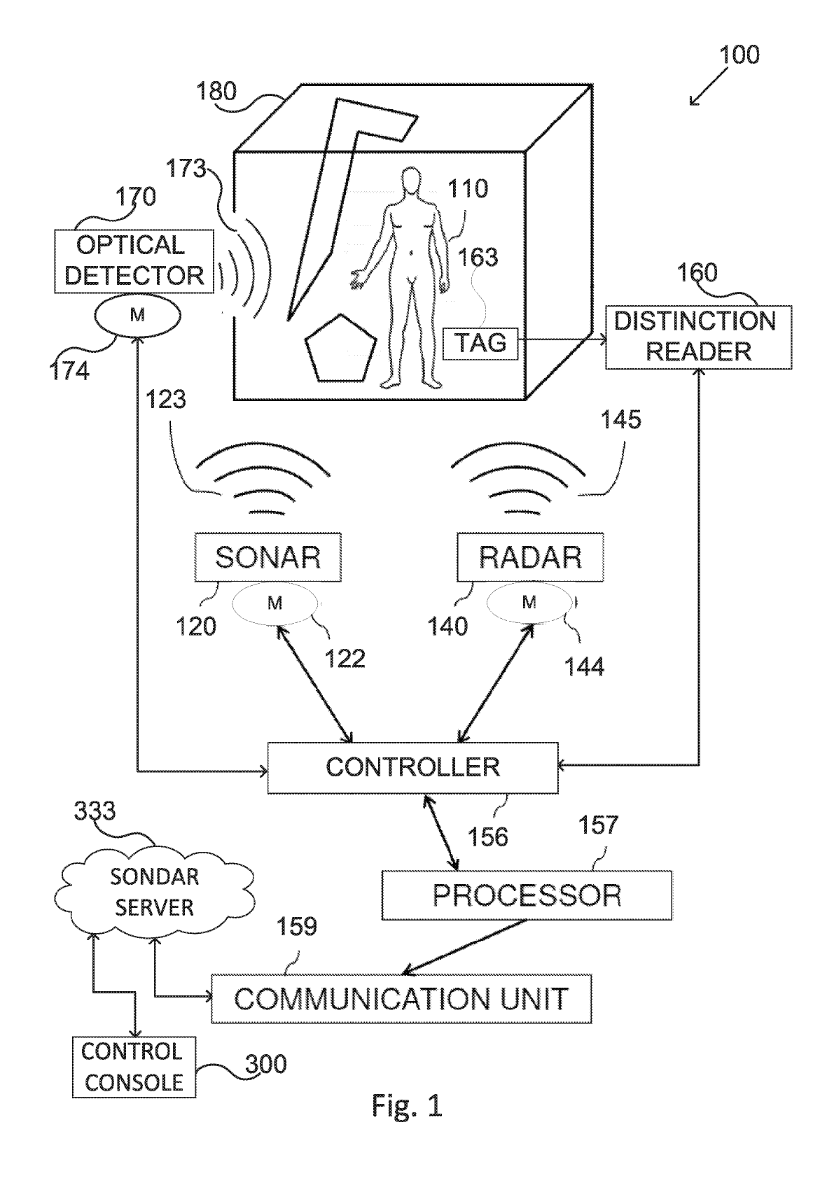

Referring now to FIG. 1 schematically illustrate a SONDAR monitoring system (SONDAR) 100 in accordance with some exemplary embodiments of the disclosed subject matter. The direction of arrows indicates the direction of information flow.

The SONDAR 100 comprises a sonar module 120, and a radar module 140, both of which are controlled by a controller 156 and processor 157, whereby the SONDAR 100 is capable of remotely monitor space 180.

It should be noted that in this disclosed subject matter, space 180 is a space having a predefined perimeter, primarily indoor space that may comprise an adjacent outdoor yard. In some exemplary embodiments, the space 180 may be a house, a hospital room, an office a villa, a combination thereof, or the like.

It is appreciated that the monitored space 180 may include at least one object 110 to be remotely monitored, whereby such objects may be inanimate or alternatively moving animate objects, for instance humans and/or animals.

In some embodiments, additional modules may also be controlled by the controller 156 and processor 157 having compatible software, such that other technologies may also be utilized in the remote monitoring of the predefined space 180.

The sonar module 120 may use ultrasonic waves 123, and the radar module 140 may use microwaves 145, in order to monitor the space 180. Optionally, both the sonar module 120 and the radar module 140 may operate simultaneously while monitoring the same space 180. The controller 156 may simultaneously accumulate information from the complementary sonar module 120 and radar module 140, such that enhanced monitoring may be achieved for the activity inside the space 180. Specifically, the monitored activity may include at least one of the following:
Collecting patterns for the motion of the object.
Collecting activity and bio-medical signals.
Tracking the movement of the object.
Identification of fall situation.

The processor 157 of SONDAR 100 further connected to a communication unit (CU) 159, wherein the direction of arrows indicates the direction of information flow.

In some exemplary embodiments, a CU 159 may be a relay for transceiving information to at least one control console (CC) 300. CC 300 may be a computerized workstation configured to provide predefined personnel with user's interface for obtaining information, detected by SONDAR 100, concerning one or more monitored subjects. The information may comprise: text messages visualized observation, sound/voice, test results of subjects, vital measurements reports, alerting events, movements of subjects, a combination thereof, or the like. In some exemplary embodiments, CC 300 may be used by predefined personnel to audibly or alphanumerically communicate with one or more monitored subjects. Additionally or alternatively, CC 300 may be utilized by predefined personnel to perform the methods depicted in Fig., such as performing calibration sequence to the SONDAR 100.

In some exemplary embodiments, CU 159 and CC 300 may communicate via SONDAR server 333 over the internet or over a local area network (not shown). In some exemplary embodiments, SONDAR server 333 may comprise a plurality of processing devices, services and data repositories. SONDAR server 333 may be deployed locally (e.g., a hospital, nursing home, or the like) or in a remote location that may comprise a collection of remote processing devices and services, such as AWS cloud-computing platform. Additionally or alternatively, SONDAR server 333 may be utilized to perform computations required by SONDAR 100 or any of it subcomponents.

The ultrasonic waves 123 of the sonar module 120 may be utilized to detect the location and also motion patterns of the at least one object 110 inside the space 180, by sending a predefined ultrasound pulse and then measuring the time of arrival for the sequence of signals reflected back from the space 180. Such a measurement may be particularly useful in initially mapping all objects in the space 180 and tracking their movement, so that an alert may be sent to CC 300 via the CU 159 in case that a predefined event (e.g. sudden lack of movement) has been detected by the SONDAR 100. For example, the monitoring system may map a living-room with a person standing near a table and three chairs, so that tracking the movement of the person relatively to the position of the table and chairs may cause an alert if the system detects that the person has tripped over a chair and fallen.

The microwaves 145 of the radar module 140 may be utilized to measure the interference of signals returned from the objects (for instance measuring in comparison to a local oscillator) such that monitoring of small movement may be achieved. Particularly, detection of the heart rate and/or the respiratory rate may be enabled with measurement of signals returned from the chest of the object 110. Such a measurement may be particularly useful in initially mapping all objects in the space 180 and tracking their bio-mechanical signature, so that an alert may be sent to CC 300 via the CU 159 in case that a predefined event (e.g. a sharp drop in breathing rate) has been detected by the SONDAR 100.

It is appreciated that using only the sonar module 120 or the radar module 140 cannot provide the enhanced monitoring that can be achieved with the combined system. Specifically, the sonar module 120 may be used to locate the position of a person (a moving target object, and/or an object added on the background) in order to analyze the activity of the objects and possibly to generate alerts (e.g. for potential obstacles, or an identification of a fall). The high precision radar module 140 may be operated periodically (for instance at predetermined time periods) and corresponding to indications from the sonar module 120.

In some embodiments, the radar module 140 may be used as a back-up detection device in case that the pathways for the sonar module 120 is obstructed, since the microwaves 145 of the radar module 140 are capable of penetrating obstacles (in contrast to the ultrasonic waves 123), such that the SONDAR 100 keeps receiving monitoring information (e.g. tracking the movement of the object 110 with the radar module 140).

The ultrasonic waves 123 of the sonar module 120 are preferably in the frequency range of 40-200 KHz. The sonar module 120 may send the ultrasonic waves 123 towards the space 180, so as to monitor signals that are reflected back from the at least one object 110 inside the space of interest 180. Similarly, the electromagnetic microwaves 145 of the radar module 140 are preferably in the frequency range of 0.5-60 GHz. The radar module 140 may send the microwaves 145 towards the space 180, so as to monitor signals that are reflected back from the at least one object 110 inside the space of interest 180 (for instance a bedroom, a yard, etc.).

In some exemplary embodiments of the disclosed subject matter, SONDAR 100 may comprise radar and sonar guiding options. A radar guiding module 144 is a movable unit and may be coupled to the radar module 140, and also being controlled by the control unit 156. Thus, the positioning of the radar module 140 may be manipulated by the radar guiding module 144 in order to direct the microwave beams towards a point of interest in the selected space 180. For example, an emergency situation detected by the sonar module 120 may indicate that the subject 110 has fallen and is lying on the left side of the room 180. The control unit 156 may then manipulate the radar guiding module 144 to move a few centimeters to the left in order to focus the microwave beams onto the exact location of the monitored subject 110. Such guiding module 144 may be operated with various means, for instance mechanical, electronic, etc.

It is appreciated that guiding of the radar module may have at least one of the following advantageous features:
The microwave beams of the radar module may now be aligned precisely to the monitored target, and thus use microwaves with considerably lower power (since a smaller area needs to be monitored).
Improvement in the signal to noise ratio, i.e. the signal returned from the monitored target compared to other signals that are caused by different movements in the monitored space.
Guiding the radar module to monitor bio parameters of a specific subject in a space containing several people.

Additionally, a Doppler sonar guiding module 122 is a movable unit and may be coupled to the sonar module 120, and also being controlled by the control unit 156. Thus, the positioning of the sonar module 120 may be manipulated by the sonar guiding module 122 in order to direct the ultrasonic waves towards a point of interest in the selected space 180. It should be noted that the Doppler sonar guiding module 122 may be an embedded element of the sonar module 120, or alternatively a separate module.

The Doppler sonar guiding module 122 may provide continuous tracking of the velocity patterns of different organs in the body of the monitored subject, such patterns may be an important indicator for many of the abovementioned features. For example, an emergency situation detected by the sonar module 120 may indicate that the subject 110 has fallen and is lying on the right side of the room 180. The control unit 156 may then manipulate the sonar transducer of the sonar guiding module 122 to move a few centimeters to the right in order to focus the ultrasonic waves of the sonar module 120 onto the exact location of the monitored subject 110. Such sonar guiding module 122 may be operated with various means, for instance mechanical, electronic, etc. In another example, an emergency situation detected by the sonar module 120, such as dangerous movement of the heart, and/or combined detection of several organs, may indicate that the subject 110 may instantly fall so that an alarm may be provided to the subject 110 and thus prevent a fall. It should be noted that long term change of relative velocities (of different organs) may contribute to determining deterioration of improvement in the health condition of the subject 110.

It is appreciated that guiding of the sonar module with complimentary information from the radar module, may provide reduction of false signals measured by the radar module and caused by gross organ motion, such that the sensitive breathing and heart beat signals may be accurately extracted.

In some embodiments, the SONDAR 100 further comprises a moveable audio sensor (not shown) capable of detecting minute audio signals from the monitored subject. Optionally, the moveable audio sensor may also be controlled by the controller of the system. The measured audio signals may be used to analyze activity and identify predetermined patterns such as stress or falls. The measured audio signals may also be used for accurate remote duplex interactions between the monitored subject and a remote station.

It is appreciated that detection of falls for the monitored subjects may be a particularly important feature, for instance for home care of the elderly, children, people with disabilities, a combination thereof, or the like. Identification of a fall incidence requires detection of a high acceleration or velocity downwards, with sharp change of body organ maneuvers, followed by partial or total immobility, and possible alternation of vital sign patterns. The complimentary monitoring achieved with the sonar and radar modules allows tracking of complex signatures of limb movement as well as general center of mass dynamics that may provide good indications for the potential falling. Since the SONDAR 100 is particularly efficient in locating general motion of subjects towards (or away from) the sonar and radar modules, and it would therefore be advantageous to provide such a system mounted on the ceiling such that fall identification may be optimized.

In case that the SONDAR 100 is mounted onto a wall, the system may be configured on vertically multiple lobe emission patterns, each at a different frequency, such that typical vertical motion of the monitored subject can be tracked by the time lag of signals created between the beams of the top and bottom nodes (relative to the floor). Optionally, the monitoring system may be configured with a single emitter and vertically spaced dual detector with phase sensitive detection. By measuring the time dependent phase differences, it may be possible to extract the accurate vertical trajectory of a falling subject.

In some exemplary embodiments of the disclosed subject matter, the radar module 140 and the sonar module 120 of SONDAR 100 may be replaced by at least one pulsed sonar monitoring module (not shown). The at least one pulsed sonar monitoring module (PSMM) is capable of transmitting ultrasonic waves onto the space 180 selected for monitoring. The at least one PSMM may be controlled by a controller 156 that is in turn operated by processor 157. Optionally, the SONDAR 100 equipped with PSMM capability may further comprise at least one sonar guiding module, such as guiding module 122, capable of moving at least one PSMM in a desired direction, and/or a CU 159 capable of sending an alert to personnel monitoring CC 300.

In some embodiments, the at least one PSMM may be air operated, similarly to commercially available sonar that are used to track the location of people by measuring the signal's time of arrival (with typical accuracy of several centimeters). Typically, short ultrasonic pulses are emitted (having carrier frequencies of about 40-200 KHz), and reflected back from various objects, such that the pulse's time of arrival is proportional to the distance from the sonar unit. For range of several meters, a typical distance resolution is about 1 cm.

The at least one PSMM may be positioned in proximity of the space 180 and the processor 157 may measure both primary as well as secondary sonar echoes in order to monitor the subject 110, for instance track echoes reflected from a wall. Optionally, the processor 157 may extract dynamics of the secondary sonar echoes, which can then be translated into the recording of human presence and/or vital signs (including respiration and heart rate). In some embodiments, the at least one PSMM is positioned inside the space 180.

Some commercially available broad beam sonars operated in a closed space (e.g. in a room), have been used to record multiple targets, while unavoidable multiple secondary echoes, for instance signals arriving to the sonar detector from the targets not directly but after hitting a wall are considered as “noise” (clutter). This generates a very complex unique pattern of recorded signals at the receiver, which is usually problematic for the conventional systems if a specific target is to be tracked within the monitored space. Preferably, the air operated PSMM (with pulsed operation) may be operated in the monitored space 180, in order to generate such complex patterns of multiple reflection signals. Then, the recorded complex pattern may then be used as a very detailed signature of the monitored space 180. Additionally, the processor 157 may be employed to interpret any modification of that signature in order to detect with high sensitivity the activity and/or vital signs of the subject 110 (in contrast to the commercially available basic sonar resolution).

It should be noted that small motions caused due to bio-activity (e.g. of the chest wall) cannot be detected directly under such conditions, however when the acoustic beam is modulated such that the beam further propagates (e.g. and hits a wall or furniture) and reflected back to the sonar detector, then the angular amplification due to the long path of the secondary echo may be translated into a large modulation of the time of arrival of the signals, thus generating a measurable signature of the vital signs. A subject 110 entering the monitored space 180 may create an additional ultrasonic reflector, which may be tracked in order to find the position and movement of the subject (as a procedure well known in prior art).

In some embodiments, an additional signature (of the subject 110) may be identified by modifying the abovementioned detailed pattern in a more detailed manner. It is appreciated that the human body constantly radiates heat to the surrounding environment, so that even without additional indications such as breathing, speaking or moving, the sound velocity at areas near the subject 110 typically changes. As a result, the structure of the signature may be modified and become non-stationary, namely the signature starts ‘breathing’, with peaks becoming valleys etc. Thus, a very good indication for the presence of a living subject 110 may be received, even if the subject does not move.

It should be noted that during a breathing cycle, a substantial change occurs due to the movement of the chest, whereby hot air is emitted causing motion of ambient air. These phenomena may cause a dynamic modification to the sonar signature of the monitored space 180, which can be traced (e.g. using processing of frame difference and frequency analysis) to extract respiration activity and breath rate. Even very small changes due to heart beat may be amplified enough by the structure of the monitored space 180 in order to give a recordable secondary echo modulated by breath and heart rate patterns. Optionally, the monitored space 180 may act as an essential part of the system, namely a sensitivity amplifier of very small signals due to the distance angular multiplication.

In some exemplary embodiments of the disclosed subject matter, SONDAR 100 may comprise an optical detector 170 having a substantially coarse resolution such that the generated optical information is not sufficient for identification of a particular person, and accordingly a detailed picture of the organs of the person cannot be produced, thereby providing maximal privacy to the monitored subject 110. The optical detector 170 produces a general shape (or “blob”) with an approximation of the subject 110, to be compared with tracking and analyzing of the movements of the “blob” in order to allow monitoring. The optical detector 170 may use typical optical technology (e.g. standard video cameras) to transmit optical beams 173 onto the space 180 selected for monitoring, such that the activity of the subject 110 may be monitored and optionally also provide information on limb maneuvers (e.g. with higher moment signal processing of the details of the “blob”).

The optical detector 170 may be controlled by a controller 156 that is in turn operated by processor 157, for instance with digital signal processing (DSP). Optionally, the optical monitoring system 170 may further comprise at least one optical guiding module 174 capable of moving the optical detector 170 in a desired direction, and/or a CU 159 capable of sending an alert to personnel monitoring CC 300. It is appreciated that the processed information from the optical array does not create a final “video” image (not even a local pre-processing image) since the optical detector array 170 does not employ cameras, and therefore the privacy of the monitored subject is not compromised.

In some embodiments, the optical detector 170 comprises a low resolution optical detector array, preferably in the visible and/or near-IR spectral range that can be detected by common silicon detectors. The resolution of such a detector array does not exceed for instance 5×25 pixels for a signature of a subject, or any identifying feature regarding the identity of the subject. Optionally, the detector array may be combined with at least one lens (e.g. with a pinhole aperture) and readout circuitry that may provide (grey color) data to the signal processing unit 157 that in order to perform a substantial set of monitoring operations, whereby the generated information does not compromise the privacy of the monitored subject 110. It is appreciated that the monitoring information from the optical detector 170 provides low resolution data to be processed by dedicated tracking algorithms, and is sufficient to track the presence and/or activity, using low cost processors with dedicated.

In some embodiments, a standard (potentially low resolution) camera using hardware with encoded large area binning of the camera pixels may be employed in the optical detector 170, such that the output signal from the camera may be very coarse (e.g. 10×10 pixels) image. Optionally, during identified emergency situations (e.g. a fall of the subject 110), and given a suitable permission, a remote operator may stop the binning operation and generate a full resolution video image for better control of the emergency situation. Alternatively, when an emergency situation is identified, the camera automatically stops the binning operation.

In some exemplary embodiments of the disclosed subject matter, SONDAR 100 may be configured to operate as location monitoring system. In such configuration SONDAR 100 at least one of the, abovementioned, monitoring modalities: sonar module 120; radar module 140; optical detector 170; moveable audio sensor; a combination thereof, or the like; may be configured as high sensitivity activity sensor (activity sensor).

The activity sensor can be configured for monitoring subject 110 activity, wherein activity sensor transmits a substantially narrow beam in order to sufficiently cover only the immediate vicinity of subject 110. The at least one activity sensor may be controlled by a controller 156 that is in turn operated by a central processing unit 157. Optionally, the at least one monitoring modalities, configured as activity sensor may further comprise location guiding module, such as for example guiding module 122, capable of moving the activity sensor in a desired direction. The location guiding module may be an electro-mechanical module, electrical or other modules, including mirror galvanometers, fast steering mirrors, phased array antennas and/or transducers. In some embodiments, the location guiding module may also provide control of beam width coverage (i.e. broad, narrow, etc.).

In the exemplary embodiments of, location monitoring configuration, the SONDAR 100 further comprises at least one tag 163 that is preferably coupled to the monitored subject 110 inside the monitored space 180 (for instance wearable by the subject), The information from the at least one tag 163 may be detected by at least one distinction reader 160 that is also controlled by the control unit 156. In some exemplary embodiments, the at least one distinction reader 160 may be configured to read a plurality of at least one tag 163, wherein the at least one tag 163 can be associated with one or more monitored subjects, such as subjects 110. In such embodiments, the distinction reader 160 provides to SONDAR 100 distinction between the one or more monitored subjects that may be present in monitored space 180. Additionally or alternatively, location information with (two or three dimensional coordinates) from the distinction reader 160 that is transferred to the control unit 156 and processed by the central processing unit 157, may be further transferred to the at least one location guiding module in order to align the activity sensor with the determined location of the monitored subject 110. It is appreciated that using such location information in order to align the guiding module may also be employed in any of the abovementioned embodiments.

The at least one tag 163 may be carried by the monitored subject 110 and comprise at least one of the following: an RF beacon with receivers in the monitored space 180 (e.g. Bluetooth receiver), and/or an RFID tag (passive or active) and identified by a remote interrogator, and/or a magnetic tag with compatible magnetic detectors. Additional options may include sonar, radar, acoustic, optical locators etc.

Usually, the background of the monitored space 180 is full with disturbances, clutter and noise, such that small signals may be difficult to retrieve. Thus, in order to provide a high signal to noise ratio, it is advantageous to narrow the monitoring sensor's field of view to an angular extent including only the monitored subject 110, wherein there is no need to reduce the overall coverage of the monitored space 180.

In some embodiments, the activity sensor may operate with a broad beam, thereby covering a substantial part of the monitored space 180, such that upon a command from the control unit 156, that beam may be narrowed again and directed to cover the location of the monitored subject 110. Optionally, the location of the monitored subject 110 may be continuously detected only by the broad beam or alternatively by another location detector.

In some embodiments, the activity sensor is an acoustic sensor, and the transmitted beam may also be directed to the detected location in order to send directed speech to the monitored subject 110 (for instance to detect a cry for help from the subject or alternatively send instructions). Such a feature may be accomplished with a phased array of receiving microphones that may also be inversed and used as transmitters (i.e. speakers). In such a way a useful high quality conversation between the monitored subject 110 (potentially under distress) and a remote monitoring station may be held, while the audio equipment may be remotely mounted (e.g. on a wall).

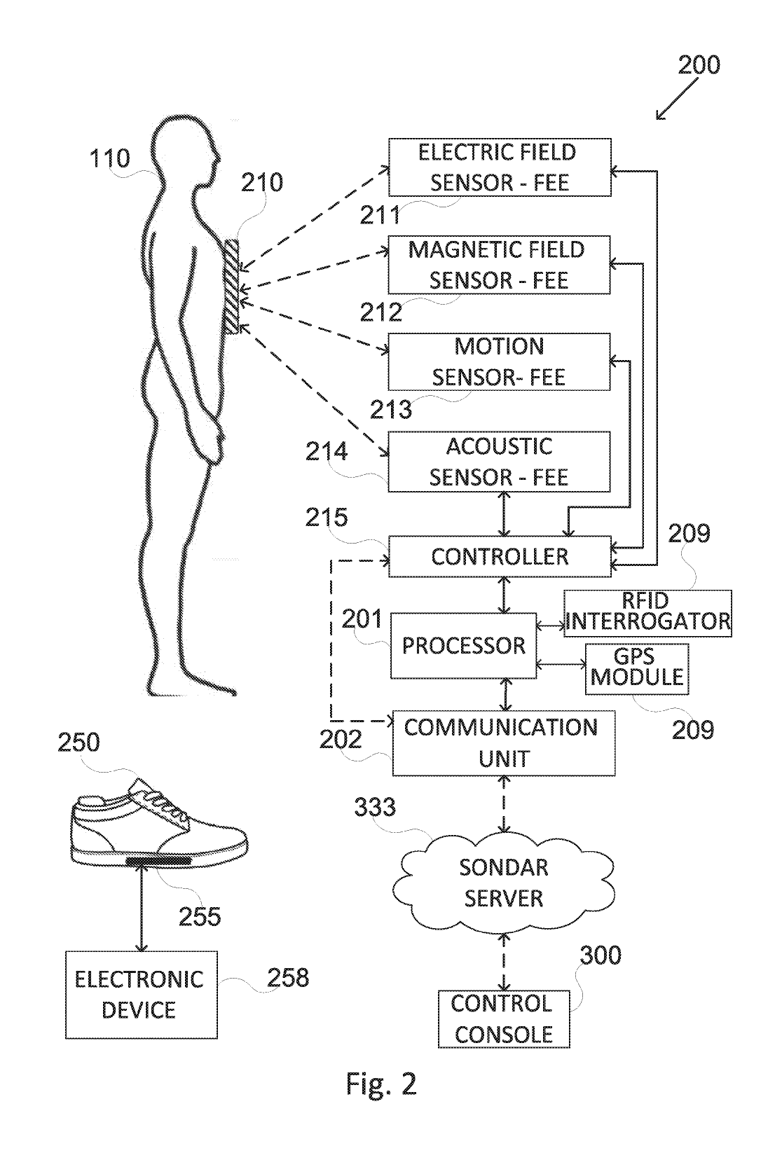

Referring now to FIG. 2 schematically illustrates a configuration for proximity monitoring system (PM) 200 in accordance with some exemplary embodiments of the disclosed subject matter.

Similar to SONDAR 100 the PM 200 may include at least one object 110 to be remotely monitored, whereby such objects may be inanimate or alternatively moving animate objects, for instance humans and/or animals. Conversely, the PM 200 is not restricted for monitoring subjects in a predefined perimeter, and thus may be adoptable to both indoor and outdoor monitoring. In some exemplary embodiments, the use of PM 200 is primarily suitable for outdoor activities, traveling, subjects roaming in campuses, a combination thereof, or the like.

In some exemplary embodiments, PM 200 may comprise a processor 201 that may be compatibles and or interoperable with the processor 157 of SONDAR 100, regardless of form, fit and factor. The same goes for communication unit (CU) 202 and CU 159 respectively. Similar to the processor and CU of SONDAR 100, processor 201 and CU 202 are also configured to perform: sensors control, data acquisition, data processing, communication, a combination thereof, or the like.

The PM 200 system as disclosed in the present subject matter (described below) may be based, but not limited to; on an array of proximity sensors (array 210). In some exemplary embodiments, array 210 may comprise at least one electric field sensor; at least one magnetic field sensor at least one motion sensor at least one acoustic sensor; a combination thereof, or the like. It should be noted that in some embodiments, the PM 200 system may be mutuality configured with abovementioned SONDAR 100 under the supervision of SONDAR server 333. As an example: the monitoring of subject 110, wearing array 210, leaving the SONDAR 100 perimeter may be automatically changed over to the PM 200 system and vice versa.

Additionally, both SONDAR 100 and PM 200 may be synchronized by the SONDAR server 333 in order to simultaneously monitor the same at least one object at the same given time. Alternatively, upon detection of the SONDAR 100 that the at least one object is leaving space 180, the SONDAR server 333 may alert the at least one object to wear the PM 200 system. Each one of the following at least one sensor: electric field, magnetic field, motion and acoustic are controlled by controller 215 via its dedicated front end electronics (FEE). I.e. electric field FEE 211, magnetic field FEE 212, motion FEE 213 and acoustic FEE 214 respectively.

In some exemplary embodiments, the electric field sensor may be a near field electric transducer may be based on measuring electrical capacitance between the at least one non contact electric field sensor and a predetermined area of the at least one object. The capacitance may be modulated both by the relative distance of the sensor and an outer skin, of the at least one object, and by the change of dielectric constant of the sub-skin, of the at least one object, due to change in fluid volume. As an example when the sensor is placed in proximity with the chest wall the breathing and heart rate are modulating the measured capacity value by the two effects mentioned above, As yet another example, when the sensor is placed in proximity to the hand or foot the breathing and heart rate are changing capacity mainly by the blood volume change. It should be noted that the FEE circuitry can be a sensitive resonant circuitry, at a range of megahertz, yielding to high sensitivity to changes in the measured capacity. Typically, one electrode, having an area of approximately 1 to 2 centimeters, is facing the skin, of the predetermined area of the at least one object, at a distance ranging between 1 to 10 millimeter, wherein the body, of the at least one object, is serving as the other electrode (“virtual ground”). Another exemplary embodiment, involves two electrodes on a single plane facing the predetermined area, of the at least one object, wherein the predetermined area is located in the fringing field between the electrodes.

In some exemplary embodiments, the, non contact, magnetic field sensor capable of measuring electrical currents indicating changes of amounts of fluids near in the predetermined area of the at least one object. the, magnetic field sensor may be configured to measure vital signs due to change in amount of body fluid in the vicinity of the sensor. When body fluids, known to be conductive, are exposed to magnetic field, emitted from magnetic field sensor, is the fluids induce currents that creates a secondary magnetic field. The value of the secondary magnetic field is indicative of amount of body fluid that is modulated by the breath, heart beat cycle, a combination thereof, or the like. The magnetic field sensor and its FEE 212 may be utilized for these sensitive measurements of the secondary magnetic field. In some exemplary embodiments, the magnetic field sensor and its FEE 212 may be based on an inductor utilized as transceiver (e.g. a flat coil with total area of 1 to 2 centimeters). Typically, the inductor is facing the predetermined area from a distance ranging between 1 to 10 millimeter, wherein the magnetic fields operates in the megahertz's range and magnetic detection circuitry based on resonant circuits or feedback circuitry loops.

In some exemplary embodiments, an electromagnetic sensor may be an electric field a magnetic field sensor, a combination thereof, or the like.

In some exemplary embodiments, the non contact acoustic sensor configured to perform as stethoscope, wherein the acoustic sensor is ultrasensitive membrane microphone. The acoustic sensor may be a passive non contact acoustic transducer typically with metallic coated thin membrane (smaller than 2 centimeters size). The acoustic sensor may be located few millimeters away from the predetermined area. The sensitivity of the acoustic sensor and its FEE 214 may be enhanced by employing a resonant circuitry in which the membrane is a floating electrode of a capacitor and, where a fixed electrode may a part of the sensor and is part of the resonant circuit. The varying capacitance, caused by the acoustic vibration may be measured as a resonant frequency change. The resonant frequency is typically in hundreds megahertz to enable sensitive recording of body sounds in the KHz region.

A motion sensor may be a micromechanical sensor, such as an accelerometer, a magnetometer, a gyro, an altimeter, a combination thereof, or the like. In some exemplary embodiments, array 210 may be one or more electronic printed circuit board (PCB) that integrate at least one electromagnetic sensor, at least one motion sensor at least one acoustic sensor and at least one RFID tag (not shown). Additionally or alternatively, the PCB may comprise electric field FEE 211, magnetic field FEE 212, motion FEE 213 and acoustic FEE 214, controller 215, processor 201, CU 202, a combination thereof, or the like. In some exemplary embodiments, processor 201, CU 202 may be replaced by an external device, such as a smartphone a tablet, or the like. Wherein, a controller 215, which resides on the PCB, further comprises the capability to wirelessly communicate with processor 201 via CU 202.

The PCB comprising array 210 may be packaged within a garment wearable near the chest of monitored subject 110.

The PM 200 system comprises at least one electromagnetic sensor adjacent to a predetermined area on the chest wall of the monitored subject 110. The at least one electromagnetic sensor is monitored by corresponding electric and magnetic field sensors

FEE 211 & 212 that may measure capacitance and/or charges at high accuracies of the chest wall, whereby the electromagnetic sensor do not contact the skin of the monitored object 110.

It is appreciated that commercially available contact based measurements use electrical electrodes touching the skin (e.g. ECG) or optical means (e.g. with light sent through exposed skin), probing the blood flow to extract heart rate, and therefore non-contact measurements may provide an advantageous solution, since they do not require exposed skin areas, do not contribute to skin allergies, and are more robust (do not suffer from instability due to loss of contact).

The electric and magnetic field sensors FEE 211 & 212 may be controlled by a controller 215 that is in turn operated by a processor 201. Optionally, the PM 200 may further comprise a communication unit 202 capable of sending an alert to predefined personnel. The output of the electric and magnetic field sensors FEE 211 & 212 is finally processed by the processing unit 201 in order to extract the required bio vital signals rhythm from the electromagnetic sensor of array 210.

The PM 200 may be positioned in the vicinity of a monitored subject 110 (e.g. on a chair, bed, or the like), or alternatively wear by the user, with the processing unit 201 translating the recorded changes in charge and/or capacity to breath and/or heart rates.

In some embodiments, the PM 200 has a configuration with a single electric field sensor of array 210, and the monitored subject 110 may serve as the counterpart floating electrode (usually the ground electrode). Preferably, the front side of the single electric field sensor is aligned towards the monitored subject 110 while the backside is shielded by another (usually larger) metallic electrode, in order to reduce unwanted interferences from the other side, for instance other people approaching the monitored subject 110. Optionally, when the chest wall is moving due to breathing or heart beating, then the electrode charging is periodically modulated (inversely proportional to the distance between the electrode and the chest wall). Another contribution to the signal is related to change in the dielectric constant, e.g. due to pulsed blood flow following the heart beats.

In some embodiments, the PM 200 has a configuration with two electromagnetic sensors on the same plane with predetermined areas and inter-electrode distance. These two electromagnetic sensors (shielded by another metallic electrode) create in plane capacitor which supports fringing electrical fields extending from one plate into the surrounding “air” and ending at the second electrode. When the chest wall intersects with this fringing field, any motion due to breath, heart beat etc. may be recorded as a change in charging, and therefore measured. Optionally, the two electromagnetic sensors are located away from each other; such the monitored subject 110 may be located between those two electrodes.

It is appreciates that the PM 200 allows wearing an ultra-small apparatus (e.g. credit card size or smaller) on the clothing, and even on thick coats and yet measure the small changes due to vital signs. The PM 200 also enables mounting the system (e.g. on wall, or on a chair) while measuring the vital signs from some distance.

In some exemplary embodiments, the PM 200 comprises at least one electromagnetic sensor and at least one motion sensor, adjacent to a predetermined area on the chest wall (even over the clothing) of the monitored subject 110. The at least two sensors are monitored by corresponding electric and magnetic field sensors FEE 211 & 212 and motion FEE 213 measuring the same body phenomena, e.g. heart or lung activity, while having a different physical response function. It should be noted that the at least two sensors may measure features at high accuracies of the chest wall, whereby the sensors do not contact the skin of the monitored object 110.

The at least two sensors may be controlled by a controller 215 that is in turn operated by a processing 201. Optionally, the PM 200 may further comprise a CU 202 capable of sending an alert to predefined personnel. The simultaneous output of FEEs 211, 212 and 213 is processed by the processing 201 in order to extract the required bio vital signals rhythm from the at least two sensors, while eliminating background noise related to movements, talking etc.

The non-contact PCB portion of the PM 200 may be positioned in the close proximity of monitored subject 110 while the processor may located in vicinity of the monitored subject 110, or alternatively carried by the monitored subject 110, wherein the processor translate the recorded changes in charge and/or capacity to breath and/or heart rates.

In a preferred embodiment, a first sensor is an electromagnetic sensor and a second detector is a motion sensor. It should be noted that both the electromagnetic sensor and the motion sensor transmit information to the controller 215. The motion sensor measures global acceleration of the center of mass of the monitored subject 110 and also local acceleration of the chest wall (especially normal and up-down acceleration). Whereby, the local acceleration also relates to breathing and/or heart activities. Similarly, the electromagnetic sensor may track the relative position dynamics of the chest wall, wherein the combined information of the two sensors may provide improved extraction of the vital signs. As both type of signals (electric and motion) are highly influenced by acoustic activity, such as talking, then the combined information may assist in eliminating this background noise. Since the two sensors are measuring different parameters (acceleration and relative position) and the source for the acoustic disturbance has a different acceleration-position signature compared with the acceleration-position signature of vital signs, it is possible to separate the vital signs from the background noise while it cannot be performed from only a single sensor type. It is appreciated that the existence of two types of measurement is vital for the discrimination between the signal and noise sources.

In a further embodiment, the PM 200 may incorporate a microphone that is selectively collecting audio signals from the monitored subject 110. Such microphone recording is related predominantly to talking of the monitored subject 110. Thus, the audio signal may be used to remove audio disturbances in the received signal which is highly important in continuous recording of the vital signs.

In some exemplary embodiments of the disclosed subject matter, the PM 200 may be utilized for, non-contact, listening to the internal sounds of monitored subject 110 (human body). It should be noted that body sounds related to lung, heart and digestive system operation are highly important for extracting vital signs and additional information. Commercial medical stethoscopes (including electronic stethoscopes) are typically cumbersome and expensive units, incorporating a large acoustic cavity to amplify the weak body generated sounds and usually require contact with the skin. Thus they are very inefficient solution for a possible component in very small (low cost) wearable or carried monitoring system for continuous monitoring. Using non-contact acoustic detectors requires overcoming the following disadvantages: substantially reduction of the acoustic signal strength (very small signal is transferred from the body to air), flatness limiting the acoustic cavity, and high cost of ultra-low noise amplifiers, or very expensive cumbersome microphones.

The PM 200 may comprise at least one electromagnetic sensor capable of performing sensitive charge measurements, adjacent to a predetermined area on the chest wall (even over the clothing) of the monitored subject 110. The PM 200 may also comprise acoustic sensor integrating a first suspended transducer (membrane like) to be deformable by acoustic waves and a second fixed transducer at a short distance from the first one. The first transducer is facing the chest of the monitored subject 110 with a predetermined distance (e.g. few millimeters on top of clothing), such that it receives predominantly the acoustic signals from the monitored subject 110 and not from the surroundings. It should be noted that the at least two detectors 131, 133 may measure features at high accuracies of the chest wall, whereby the detectors do not contact the skin of the monitored object 110.

The at least one electromagnetic sensor and the at least one acoustic sensor may be controlled by a controller 215 that is in turn operated by a processor 201. Optionally, the PM 200 may further comprise a CU 202 capable of sending an alert to predefined personnel. The simultaneous output of the at least one electromagnetic sensor and the at least one acoustic sensor are processed by the processor 201 in order to transform the charge modulation due to the acoustic vibrations of the deformable electrode into useful audio signals for further processing.

The non-contact PCB portion of the PM 200 may be positioned in the close proximity of monitored subject 110 while the processor may located in vicinity of the monitored subject 110, or alternatively carried by the monitored subject 110. The processor may be utilized translating the recorded changes in charge and/or capacity to breath and/or heart rates.

It is appreciated that embodiments of non-contact listening to the internal human body sounds performed by the PM 200 are different from the commercially available measurements applied in standard microphones, which has to go through amplification and thus the sensitivity is limited by the amplifier noise, which is unacceptable for a weak signal. However, the deformable electrode movement relative to the fixed electrode modifies accordingly the charge in the at least one electromagnetic sensor, which is accurately measured.

It will be noted that the thickness of the acoustic sensor is substantially thin since the small acoustic induced electrode movements are a small fraction of a millimeter. Additionally, charge detection circuitry is sensitive and linear in this regime (e.g. at ranges of 5 orders of magnitudes), thus enabling ultrasensitive detection of very weak audio signals even at the presence of larger signals (e.g. measurements of heart beat even when the monitored subject 110 is speaking). It is appreciated that this solution is extremely small, flat, using low power, no amplification and yet much more sensitive than regular microphones, thus enabling non-contact wearable body audio measurements under uncontrolled environment.

In some embodiments, in addition to very sensitive electrical measurements, a magnetic field sensor may be used for heart and/or breathing rate measurements. The measurement corresponds to current flowing in organs (such as heart, neural systems, muscles) generating small magnetic fields, which are utilized today e.g. for advanced brain monitoring, they are too small and need major instrumentation to measure (MRI like size). Therefore, a small and flat device may be provided that generates alternating magnetic field that is transmitted by a flat coil into the body of the subject and generates current in conductive parts of the body, e.g. in the heart tissue. This secondary current generates its own magnetic field that is accurately measured using the same coil. Thus, the beating of the heart may modulate the secondary magnetic field in order to extract heart and/or breathing rate measurements etc.

In some exemplary embodiments, The PM 200 system may be utilized for outdoor use, such as traveling, recreational activities, sports activities, or any other activities performed in solitude. Such activities may face emergency situations due to self-inflicted accidents (e.g. falling), or being hit by others, unintentionally or on purpose which can result in serious injury (particularly in an isolated environment), whereby an adjoining wearable PM 200 system may automatically send a prompt distress signal with location and status information. PM 200 system comprising at least one motion sensor may be configured of detecting a predetermined position change indicating a fall. The PM 200 system may further comprise at least one global positioning satellite (GPS) module 209 capable of determining the location of the monitored subject 110. Optionally, the PM 200 system may also generate an audible siren to notify people in the vicinity of an emergency or to repel attackers. It will be noted that the PM 200 is configured to distinguish between an emergency situation (e.g. falling of the user) and regular recreational activity.

In some embodiments, the PM 200 system comprises electronic device 258 embedded within wearable items of the monitored subject 110, such as a shoe 250, watch-wristbands, clothes, a combination thereof, or the like. Additionally or alternatively, the monitored subject 110 may carry the electronic device 258 in a pocket or in handbag. Since the PCB comprising array 210 is packaged within a garment wearable near the chest of monitored subject 110, the electronic device 258 may comprise processor 201 and CU 202, wherein, the controller 215, which resides on the PCB, further comprises the capability to wirelessly communicate with processor 201 via CU 202 of the electronic device 258. It should be noted that components comprised in the electronic device 258 may utilize dedicated software that is implemented on a low power microcontroller.

Additionally or alternatively, the electronic device 258 functionalities may be embedded into articles such as mobile phones, smart-watches, smart-glasses, a combination thereof, or the like. The electronic device 258 may further comprise at least one motion sensor, GPS module (such as GPS module 209), CU 202 with GPRS, RFID reader, a combination thereof, or the like. Upon detection, the dedicated software may initiate localization by using the relevant elements of the existing device onto which the software is implemented, and the location may then be transmitted to a predetermined address accompanied with vital information as well as other monitored data.

In some exemplary embodiments of PM 200, the electronic device 258 which control and monitor array 210 and its FEEs may wirelessly communicate via Bluetooth with a smartphone of the monitored subject 110. Whereby, the smartphone automatically initiates communication with a predetermined remote address. In a further embodiment, the PM 200 system operates with low power consumption such that the intensive activity of the monitored subject 110 may be used for energy harvesting including pressure module incorporated in shoes, and/or heat and movement.

In some exemplary embodiments of the disclosed subject matter, a dedicated software operating system of the PM 200 may comprise a self-powered monitoring mode. The self-powered monitoring mode activates components of the PM 200 which are capable of operating as self-powered components, such as passive RFID tags, configured as panic button, activated by a interrogator.

Typical commercially available panic buttons are activated by a monitored subject 110 at emergency situations, and can generate a signal which is used for notifying. Such panic-buttons are either wearable or stationary, and require powering so that when activated they send a signal (e.g. radio signal) to a local transceiver. However, these panic-buttons are not a great success since they are in most cases cumbersome, need monitoring if their battery is still operative, and in addition in critical emergencies they cannot be activated by the distressed user.

In the self-powered monitoring mode the PM 200 preferably receives power by energy harvesting and comprises simple circuitry and a power storage mechanism. Specifically, In the self-powered monitoring mode the PM 200 comprises at least one sensor capable of detecting an emergency scenario, whereby the at least one sensor may be controlled by a controller 215 that is in turn operated by a processor 201. The sensor may employ passive RFID circuitry, namely a RFID interrogator 208 that may probe for the existence of RFID devices in a predetermined range. Optionally, the PM 200 may further comprise a CU 202 capable of sending an alert to predefined personnel. Preferably, upon activation of the “panic button”, i.e. detecting an emergency, the circuitry may generate and transmit a distress signal through the CU 202 until the power source is exhausted.

In some exemplary embodiments of self-powered monitoring mode, the electronic device 258 of the PM 200 further comprises an energy harvesting module, capable of supporting components that are absolutely necessary for activating emergency cycles. The emergency cycles may comprise: automatic, transparent to the user; a physical (manual) panic button; a combination thereof, or the like.

The energy harvesting module may be configured to transform energy derived from external sources; e.g. solar energy, thermal energy, wind energy, kinetic energy, a combination thereof, or the like; into electrical energy. In some exemplary embodiments, the energy harvesting module may capture, and store the electrical energy, in the electronic device 258, for performing operations of the self-powered monitoring mode. In some exemplary embodiments, at least one shoe 250 may be a kinetic energy-harvesting shoe.

In some embodiments, some components may be charged by incoming RF energy with modulated information sent back. The RF energy may be detected by the RFID interrogator 208 as an alarm, and therefore indicate an emergency event. It should be noted that in such a configuration, no power storage is required and thus leading to a further reduction of the size. In some embodiments, additional sensors may be employed in the self-powered monitoring mode, including temperature and accelerometer sensors. Such low power sensors may operate with a small amount of harvested energy and give indications on the status of the monitored subject. Optionally, these additional sensors may be operated only at the distress situation, for instance transmitting information to the RFID interrogator 208 upon activation of the panic button by the user.

In some embodiments of self-powered monitoring mode, the PM 200 may be operated automatically when an abnormality is detected by at least one of the sensors. Such feature mitigates the frequent situation of users that cannot physically press the panic button. Optionally, the at least one sensor may be activated by a physical proximity switch (e.g. capacitive or light switch) that transmits a signal when the monitored subject 110 moves a limb to close proximity of the sensor, thereby improving the chance of the monitored subject 110 receiving help in adverse situations.

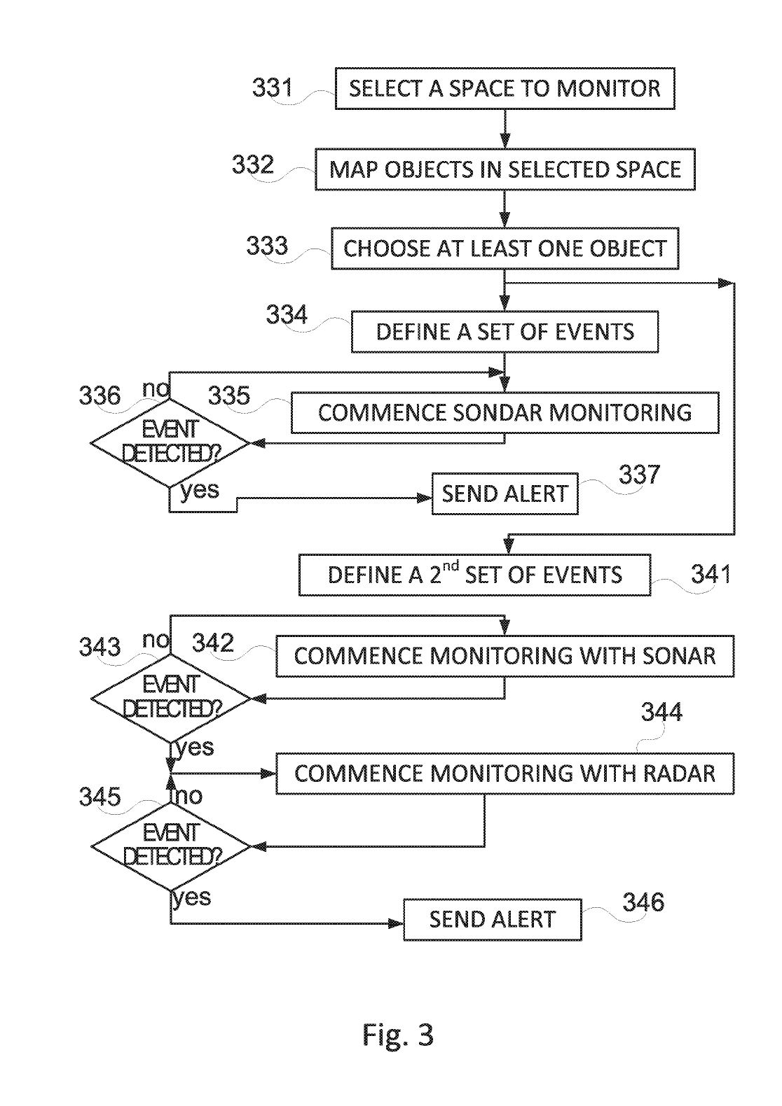

Referring now to FIG. 3 showing a flowchart diagram of a method for remotely monitoring objects in accordance with some exemplary embodiments of the disclosed subject matter.

In Step 331, space 180 (of FIG. 1) may be selected for monitoring. In some exemplary embodiments, following space selection for monitoring the SONDAR 100 (of FIG. 1) may initialize an auto-calibration routine dedicated for calibrating the measurements of the sensors utilized in SONDAR 100.

In Step 332 all objects in the selected space 180 may be mapped by sonar 120. In some exemplary embodiments, a user controlling the SONDAR 100 may supervise the mapping of all objects in the selected space 180. It should be noted that the term “user” in the present disclosed subject matter refers to predefined personnel that monitor CC 300 (of FIGS. 1 & 2). Additionally or alternatively, the mapping process may be done automatically be the SONDAR 100

In Step 333, at least one subject may be chosen among the mapped objects in the selected space 180, for continuous monitoring. In some exemplary embodiments, the at least one object, such as object 110 (of FIG. 1) in the selected space may be carried out manually by a user (for example choosing an elder resident in a home). Additionally or alternatively, the at least one subject may be chosen automatically by the processor 157 (of FIG. 1). In case that the monitored subject is chosen automatically, the subject for monitoring may be identified with a calibration process wherein the subject may perform some predefined movements in order to enable the system to lock onto the preferred subject. In some exemplary embodiments, the SONDAR 100 may be predefined to monitor any moving subject inside the selected space.

In Step 334, a set of events may be defined. In some exemplary embodiments,

Once a subject is chosen for monitoring 333, the system is required to define a set of events 34 that upon detection should trigger an alarm. Such set of events may be predefined manually for a specific subject after mapping of the space. For example, if the monitored space is a bedroom and the mapping identifies three objects as a chair, a bed, and a person, then the person may be chosen for monitoring and the defined set of events may include the subject falling of the bed, or tripping over the chair. Alternatively, the set of events may be predefined with general events, for instance a sharp drop in the heart rate (e.g. measured by the radar module) of any moving subject may cause an alarm for the system.

In Step 335, SONDAR 100 may commence SONDAR monitoring the at least one chosen subject, with the controller 156 controlling the sonar 120 and radar 140 modules (of FIG. 1) operating simultaneously.

In Step 336, processor 157 (of FIG. 1) may be utilized for checking if an event, from the predefined set of events, has been detected. In case that no event was detected, the SONDAR 100 may repeatedly monitoring the at least one chosen subject, until an event is detected. In case an event, from the predefined set of events, occurs, the SONDAR 100 may proceed to Step 337.

In Step 337, an alert may be sent to the user. In some exemplary embodiments, the alert may be sent via the CU 159 (of FIG. 1). For example, the SONDAR 100 detecting lowered heart rate of monitored subject 110 may send an alert to a dedicated device via a network to which the SONDAR 100 is connected. Optionally, the system may send an alert wirelessly to a mobile device that is carried by a user (e.g. a nurse).

It is appreciated that if the radar module 140 (of FIG. 1) operates periodically and not continuously, then the abovementioned “auto-calibration” of step 331 may still apply. Specifically: selecting a apace to monitor 331, mapping all objects in the selected space 332, choosing at least one subject to monitor 333, a combination thereof, or the like.

In Step 341, a set of events may be defined. In some exemplary embodiments, the set of events set in step 334 may be adjusted since some events detected by the continuous operation of the sonar module, may be defined to trigger the operation of the radar module. Such set of events may be predefined manually for a specific subject after mapping of the space. For example, if the monitored space is a bedroom and the mapping identifies three objects as a chair, a bed, and a person, then the person may be chosen for monitoring and the defined set of events may include the subject falling of the bed, or tripping over the chair that can be detected by the continuous operation of the sonar module. Alternatively, the set of events may be predefined with general events to be detected by the sonar module, and an additional set of events for the radar module. For instance any moving subject may be registered as an event by the sonar module, and a sharp drop in the heart rate may be registered as an event measured by the radar module.

In Step 342, SONDAR 100 may commence sonar monitoring the at least one chosen subject, with the controller 156 (of FIG. 1), wherein the sonar module may be operating continuously.

In Step 343, processor 157 (of FIG. 1) may be utilized for checking if an event, from the predefined set of events, has been detected. In case that no event was detected, the sonar module of SONDAR 100 may repeatedly monitor the at least one chosen subject, until an event is detected. If an event, from the predefined set of events for the sonar module, has been detected, then the SONDAR 100 may proceed to step 344.

In step 344, the SONDAR 100 may trigger the radar module to commence monitoring, optionally, while the radar module commences monitoring, the sonar module continues monitoring as well.

In Step 345, processor 157 (of FIG. 1) may be utilized for checking if an event, from the predefined set of events for the radar module, has been detected. In case that no event was detected, the radar module of the SONDAR 100 may repeatedly monitoring the at least one chosen subject, until an event is detected. Optionally, a predetermined time period may be determined for the radar module monitoring, and in case that no event has been measured by the radar then the radar may stop the operation and await until an additional event is detected (step 343) by the sonar module. If an event, from the predefined set of events for the radar module, has been detected, then the system may proceed to Step 346

In Step 346, an alert may be sent to the user. In some exemplary embodiments, such alert may be sent via the CU 159 (of FIG. 1). For example, SONDAR 100 detecting lowered heart rate in the monitored subject may send an alert to a dedicated device via a network to which the SONDAR system is connected. Optionally, the system may send an alert wirelessly to a mobile device that is carried by the user (e.g. a nurse).

It is appreciated that the integrated operation of both the sonar module and the radar module may have at least one of the following advantageous features:

Using microwaves with the radar module infrequently and/or only when needed (e.g. at an emergency situation), triggered by the sonar module. Such a feature may be particularly important from a psychological point of view, since many people object to being exposed to continuous radiation (e.g. microwave) even when the radiated power extremely low (much lower than other radiating elements in the environment, such as mobile phones). Therefore, using minimal operation of the radiating element eliminates such “psychological” hurdles.

The sonar module may indicate non-eventful or “calm” periods, such that weak bio-medical signals may be efficiently measured by the radar module while there is no disturbance due to substantial motion, speech, etc.

The microwaves of the radar module can penetrate almost any object, while the ultrasonic waves of the sonar module may be blocked or absorbed by soft objects, and completely reflected from hard surfaces. For example, a person standing behind some furniture cannot be directly tracked by the sonar module; however such an obstruction may be compensated by the “back-up” measurement provided with the radar module, thereby allowing continuous non-obstructive operation.

The sonar and radar modules are complementarily to each other. The sonar module can track objects at large distances and even beyond corners, due to high ultrasonic reflectivity of the walls, in contrast to the penetrating microwaves of the radar module. Also, the radar module can measure movement of a chest wall of a person even under a thick fabric, while the ultrasonic waves of the sonar module are completely absorbed.

Some false information may be eliminated due to the different nature of the sonar and radar modules, specifically the microwaves of the radar module can pass through walls and collect signals from other spaces thereby causing false information regarding objects that are not in the monitored space. However, in combination with signals from the sonar module, which cannot go through walls, can ensure that the measured signals relate only to the required selected space. Additionally, as signals measured outside of the predefined area are ignored by the combined modules, it may be possible to fully map the desired space for monitoring.

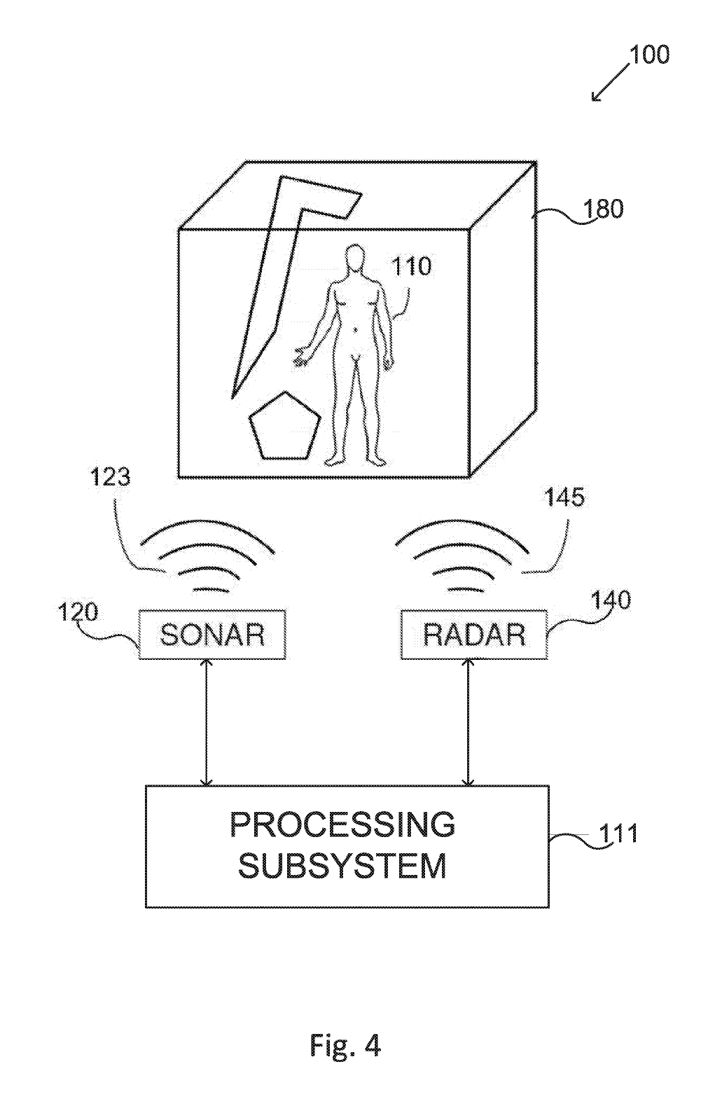

Referring now to FIG. 4 schematically illustrate an essential SONDAR monitoring system in accordance with some exemplary embodiments of the disclosed subject matter.

The SONDAR 100 comprises a sonar module 120, and a radar module 140, both of which are controlled by processing subsystem 111, whereby the SONDAR 100 is capable of remotely monitor space 180. It should be noted that in this disclosed subject matter, space 180 is a space having a predefined perimeter, primarily indoor space that may comprise an adjacent outdoor yard. In some exemplary embodiments, the space 180 may be a house, a hospital room, an office a villa, a combination thereof, or the like. It is appreciated that the monitored space 180 may include at least one object 110 to be remotely monitored, whereby such objects may be inanimate or alternatively moving animate objects, for instance humans and/or animals.

The sonar module 120 may use ultrasonic waves 123, and the radar module 140 may use microwaves 145, in order to monitor the space 180. Optionally, both the sonar module 120 and the radar module 140 may operate simultaneously while monitoring the same space 180.

The processing subsystem 111 may simultaneously acquire data from the complementary sonar module 120 and radar module 140, such that enhanced monitoring may be achieved for the activity inside the space 180. Specifically, the monitored activity may include at least one of the following:
Collecting patterns for the motion of the object.
Collecting activity and bio-medical signals.
Tracking the movement of the object.
Identification of fall situation.

The processing subsystem 111 may further comprise the capability relay information users utilizing external devices (not shown) The information may comprise: text messages visualized observation, sound/voice, test results of subjects, vital measurements reports, alerting events, movements of subjects, a combination thereof, or the like.

The ultrasonic waves 123 of the sonar module 120 may be utilized to detect the location and also motion patterns of the at least one object 110 inside the space 180, by sending a predefined ultrasound pulse and then measuring the time of arrival for the sequence of signals reflected back from the space 180. Such a measurement may be particularly useful in initially mapping all objects in the space 180 and tracking their movement, so that an alert may be sent to a user in case that a predefined event (e.g. sudden lack of movement) has been detected by the SONDAR 100. For example, the monitoring system may map a living-room with a person standing near a table and three chairs, so that tracking the movement of the person relatively to the position of the table and chairs may cause an alert if the system detects that the person has tripped over a chair and fallen.

The microwaves 145 of the radar module 140 may be utilized to measure the interference of signals returned from the objects (for instance measuring in comparison to a local oscillator) such that monitoring of small movement may be achieved. Particularly, detection of the heart rate and/or the respiratory rate may be enabled with measurement of signals returned from the chest of the object 110. Such a measurement may be particularly useful in initially mapping all objects in the space 180 and tracking their bio-mechanical signature, so that an alert may be sent to the user in case that a predefined event (e.g. a sharp drop in breathing rate) has been detected by the SONDAR 100.

It is appreciated that using only the sonar module 120 or the radar module 140 cannot provide the enhanced monitoring that can be achieved with the combined system. Specifically, the sonar module 120 may be used to locate the position of a person (a moving target object, and/or an object added on the background) in order to analyze the activity of the objects and possibly to generate alerts (e.g. for potential obstacles, or an identification of a fall). The high precision radar module 140 may be operated periodically (for instance at predetermined time periods) and corresponding to indications from the sonar module 120.

In some embodiments, the radar module 140 may be used as a back-up detection device in case that the pathways for the sonar module 120 is obstructed, since the microwaves 145 of the radar module 140 are capable of penetrating obstacles (in contrast to the ultrasonic waves 123), such that the SONDAR 100 keeps receiving monitoring information (e.g. tracking the movement of the object 110 with the radar module 140).

The ultrasonic waves 123 of the sonar module 120 are preferably in the frequency range of 40-200 KHz. The sonar module 120 may send the ultrasonic waves 123 towards the space 180, so as to monitor signals that are reflected back from the at least one object 110 inside the space of interest 180. Similarly, the electromagnetic microwaves 145 of the radar module 140 are preferably in the frequency range of 0.5-50 GHz. The radar module 140 may send the microwaves 145 towards the space 180, so as to monitor signals that are reflected back from the at least one object 110 inside the space of interest 180 (for instance a bedroom, a yard, etc.).

It is appreciated that detection of falls for the monitored subjects may be a particularly important feature, for instance for home care of the elderly. Identification of a fall incidence requires detection of a high acceleration or velocity downwards, with sharp change of body organ maneuvers, followed by partial or total immobility, and possible alternation of vital sign patterns. The complimentary monitoring achieved with the sonar and radar modules allows tracking of complex signatures of limb movement as well as general center of mass dynamics that may provide good indications for the potential falling. Since the SONDAR 100 is particularly efficient in locating general motion of subjects towards (or away from) the sonar and radar modules, and it would therefore be advantageous to provide such a system mounted on the ceiling such that fall identification may be optimized.

In case that the SONDAR 100 is mounted onto a wall, the system may be configured on vertically multiple lobe emission patterns, each at a different frequency, such that typical vertical motion of the monitored subject can be tracked by the time lag of signals created between the beams of the top and bottom nodes (relative to the floor). Optionally, the monitoring system may be configured with a single emitter and vertically spaced dual detector with phase sensitive detection. By measuring the time dependent phase differences, it may be possible to extract the accurate vertical trajectory of a falling subject.

In some exemplary embodiments of the disclosed subject matter, the radar module 140 and the sonar module 120 of SONDAR 100 may be replaced by at least one pulsed sonar monitoring module (not shown). The at least one pulsed sonar monitoring module (PSMM) is capable of transmitting ultrasonic waves onto the space 180 selected for monitoring. The at least one PSMM may be controlled by the processing subsystem 111.

In some embodiments, the at least one PSMM may be air operated, similarly to commercially available sonar that are used to track the location of people by measuring the signal's time of arrival (with typical accuracy of several millimeters). Typically, short ultrasonic pulses are emitted (having carrier frequencies of about 40-200 KHz), and reflected back from various objects, such that the pulse's time of arrival is proportional to the distance from the sonar unit. For range of several meters, a typical distance resolution is about 1cm.

The at least one PSMM may be positioned in proximity of the space 180 and the processing subsystem 111 may measure both primary as well as secondary sonar echoes in order to monitor the subject 110, for instance track echoes reflected from a wall. Optionally, the processing subsystem 111 may extract dynamics of the secondary sonar echoes, which can then be translated into the recording of human presence and/or vital signs (including respiration and heart rate). In some embodiments, the at least one PSMM is positioned inside the space 180.

Some commercially available broad beam sonar operated in a closed space (e.g. in a room), have been used to record multiple targets, while unavoidable multiple secondary echoes, for instance signals arriving to the sonar detector from the targets not directly but after hitting a wall are considered as “noise” (clutter). This generates a very complex unique pattern of recorded signals at the receiver, which is usually problematic for the conventional systems if a specific target is to be tracked within the monitored space. Preferably, the air operated PSMM (with pulsed operation) may be operated in the monitored space 180, in order to generate such complex patterns of multiple reflection signals. Then, the recorded complex pattern may then be used as a very detailed signature of the monitored space 180. Additionally, the processing subsystem 111 may be employed to interpret any modification of that signature in order to detect with high sensitivity the activity and/or vital signs of the subject 110 (in contrast to the commercially available basic sonar resolution).

It should be noted that small motions caused due to bio-activity (e.g. of the chest wall) cannot be detected directly under such conditions, however when the acoustic beam is modulated such that the beam further propagates (e.g. and hits a wall or furniture) and reflected back to the sonar detector, then the angular amplification due to the long path of the secondary echo may be translated into a large modulation of the time of arrival of the signals, thus generating a measurable signature of the vital signs. A subject 110 entering the monitored space 180 may create an additional ultrasonic reflector, which may be tracked in order to find the position and movement of the subject (as a procedure well known in prior art).

In some embodiments, an additional signature (of the subject 110) may be identified by modifying the abovementioned detailed pattern in a more detailed manner. It is appreciated that the human body constantly radiates heat to the surrounding environment, so that even without additional indications such as breathing, speaking or moving, the sound velocity at areas near the subject 110 typically changes. As a result, the structure of the signature may be modified and become non-stationary, namely the signature starts ‘breathing’, with peaks becoming valleys etc. Thus, a very good indication for the presence of a living subject 110 may be received, even if the subject does not move.

It should be noted that during a breathing cycle, a substantial change occurs due to the movement of the chest, whereby hot air is emitted causing motion of ambient air. These phenomena may cause a dynamic modification to the sonar signature of the monitored space 180, which can be traced (e.g. using processing of frame difference and frequency analysis) to extract respiration activity and breath rate. Even very small changes due to heart beat may be amplified enough by the structure of the monitored space 180 in order to give a recordable secondary echo modulated by breath and heart rate patterns. Optionally, the monitored space 180 may act as an essential part of the system, namely a sensitivity amplifier of very small signals due to the distance angular multiplication.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A system for remote monitoring at least one object in a predefined space, the system comprising:
a sonar module and a radar module mutually coupled for simultaneously acquiring data about the at least one object;
at least one processing subsystem configured to perform at least one of:
control the sonar module and the radar module;
process the data;
communicate information and instructions with external device.

2-3. (canceled)

4. The system of claim 1, wherein said simultaneously acquiring data about the at least one object is achieved by monitoring signals reflected back from the at least one object, wherein the signals reflected back from the at least one object results from ultrasonic waves and electromagnetic microwaves projected to the predefined space, and wherein the ultrasonic waves and the electromagnetic microwaves are projected from the sonar module and the radar module respectively.

5. The system of claim 1, wherein the system further comprises at least one of additional sensor, and wherein the additional sensors comprising: at least one distinction reader; at least one optical detector; and at least one audio sensor,
wherein at least one RFID tag is attached to the at least one object, wherein an identification value embedded in each one of the at least one RFID tag is unique, and wherein the at least one RFID tag is utilized by the system to distinguish between at least two of the objects, and
wherein the at least one distinction reader is configured to transmit interrogatory radio frequency (RF) signals and receive RF authentication replies from the at least one RFID tag, whereby the RF authentication replies identifies the at least one object.

6-7. (canceled)

8. The system of claim 5, wherein the at least one optical detector is configured to capture an image of the at least one object in the predefined space, and wherein the image is selected from the group comprising video image; stills image; and a combination thereof.

9. The system of claim 5, further comprises the at least one audio sensor capable of detecting audio signals from the object, wherein the system is configured to analyze the audio signals in order to assist the at least one processing subsystem in determining the at least one object location.

10. The system of claim 5, wherein the at least one processing subsystem further comprises a controller, wherein the controller is configured to operate the sonar module; the radar ∘ module; and the at least one additional sensor; wherein the controller further configured to acquire data from the sonar module; the radar module; and the at least one additional sensor.

11-14. (canceled)

15. The system of claim 1, further comprises SONDAR server, wherein the SONDAR server is capable of integrating a plurality of systems for remote monitoring the at least one object in a predefined space, wherein said communicate information and instructions with external device further comprises communicating over the interne with the external device via a SONDAR server.

16. (canceled)

17. The system of claim 1, wherein the system is utilized to detect a location of the at least one object in the predefined space, wherein the location is selected from a group comprising of motion patterns; movement tracking; abrupt position change.

18. The system of claim 17, wherein the system is utilized to detect a vitals of the at least one object in the predefined space, wherein the vitals are selected from a group comprising of bio-medical signals; sharp drop in breathing rate; heart rate; and respiratory rate.

19. The system of claim 18, wherein the information comprising elements, wherein the elements are selected from a group comprising of: alerts; vital information; bio-medical signals; sharp drop in breathing rate; heart rate; respiratory rate; motion patterns; movement tracking; abrupt position change and location; wherein the information further comprises a predefined set of attributes for each element; wherein an event indicate a conflict between an element and its set of attributes; and wherein a conflict trigger an alert.

20. The system of claim 1, wherein the system further comprises at least one pulsed sonar monitoring module (PSMM), wherein the PSMM employs short ultrasonic pulses method for accurate tracking a location of the at least one object in the predefined space.

21. A system for proximity monitoring at least one object, the system comprising:
an array of non-contact sensors simultaneously acquiring data, wherein the data comprising vitals and position of the at least one object;
at least one processing subsystem configured to perform at least one of:
control the array;
process the data;
communicate information and instructions with external device.

22-23. (canceled)

24. The system of claim 21, wherein the array is embedded in a wearable item, and wherein the wearable item is adjacent to a predetermined area of the at least one object.

25. The system of claim 24, wherein the array comprising at least one of:
at least one non contact electric field sensor capable of measuring electrical capacitance between the at least one non contact electric field sensor and the predetermined area of the at least one object, wherein the electrical capacitance is indicative of vital changes;
at least one non contact magnetic field sensor capable of measuring electrical currents indicating changes of amounts of fluids near in the predetermined area of the at least one object;
at least one non contact motion sensor capable of detecting the at least one object position and motion, wherein the motion sensor is a micromechanical transducer selected from a group comprising: an accelerometer, a magnetometer, a gyro, an altimeter, and a combination thereof;
at least one non contact acoustic sensor configured to perform as stethoscope, wherein the at least one non contact acoustic sensor is ultrasensitive membrane microphone; and
wherein each sensor of the array is integrated with a dedicated front end electronics (FEE);
wherein, each FEE is configured to shape, sample, and hold an electrical signal representing a measurement of each sensor.

26-27. (canceled)

28. The system of claim 21, wherein the at least one processing subsystem further comprises at least one communication unit (CU), wherein the at least one CU is configured to:
transmit instructions to a controller; of the array
receive data from the controller;
receive instructions from the external device;
transmit the information to the external device; and
communicate with the internet.

29-30. (canceled)

31. The system of claim 21, further comprises at least one global positioning satellite system (GPS) module, wherein the GPS module is capable of determining location of the at least one object, and wherein the GPS module attaches a depiction of the location to the information.

32-33. (canceled)

34. The system of claim 21, wherein the position of the at least one object is selected from a group comprising of motion patterns; movement tracking; abrupt position change, and wherein the position depiction is attached to the information.

35. The system of claim 21, wherein the vital of the at least one object are selected from a group comprising of: bio-medical signals; sharp drop in breathing rate; heart rate; and respiratory rate; and wherein the vitals depiction is attached to the information.

36. The system of claim 21, wherein the at least one processing subsystem comprises attributes adequate for the at least one object; wherein an event indicate a conflict between the information and the attributes; and wherein a conflict automatically trigger an alert.

37-38. (canceled)

39. The system of claim 21, further comprises SONDAR server, wherein the SONDAR server is capable of integrating a plurality of systems for remote monitoring the at least one object in a predefined space, wherein said communicate information and instructions with external device further comprises communicating over the internet with the external device via a SONDAR server.

40-50. (canceled)
